(19) United States
(12) Patent Application Publication
(10) Pub. No.: US 2006/0238603 A1
(43) Pub. Date: Oct. 26, 2006

(54) System and method for printing on light-sensitive media

(75) Inventors: Douglas C. Snell, Albany, OR (US); Leo C. Clarke, Albany, OR (US); Makarand P. Gore, Corvallis, OR (US); Timothy L. Weber, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 11/115,837

(22) Filed: Apr. 26, 2005

(51) Int. Cl. B41J 2/47

(52) U.S. Cl. 347/225

(57) ABSTRACT

Systems and methods for printing on a print medium having a light-sensitive labeling layer are disclosed. The system includes a light source adapted to generate a light beam and a reflective surface adapted to deflect the light beam from the light source to a light-sensitive labeling layer of a print medium. The reflective surface is further adapted to rotate to cause the light beam to scan a scan region of the labeling layer. The light beam is adapted to activate the light-sensitive labeling layer of the print medium by causing a chemical change in the light-sensitive labeling layer to form an image.

### RELATED APPLICATION

This application relates to commonly assigned U.S. patent application Ser. No. 10/351,188, entitled “Compositions, Systems, and Methods for Imaging,” filed Jan. 24, 2003, and U.S. patent application Ser. No. 10/834,744, entitled “System and Method for Synchronization of Pixilated Labeling Media,” filed Apr. 28, 2004.

### BACKGROUND OF THE INVENTION

The present invention relates generally to the field of printing. In particular, the invention relates to methods and systems for printing on light-sensitive media.

Digital photography has become increasingly prevalent in recent years. In particular, the integration of digital cameras into a variety of hand-held devices, such as cellular telephones, personal digital assistants (PDA's) and the like, has made digital photography highly accessible.

Such digital photography allows easy access and sharing of images with others. However, for many users, a desire for the image on a printed medium still exists. The existing digital photography technology remains without an integrated printing solution. In existing systems, printing is done by transferring the captured image or data to a separate printer.

### BRIEF DESCRIPTION OF THE DRAWINGS

FIG. 1 is a diagrammatic illustration of a printing system according to an embodiment of the invention;

FIG. 2 is a schematic illustration of an embodiment of a control system for the printing system illustrated in FIG. 1;

FIG. 3 is a flow chart illustrating an embodiment of an operational process of the printing system illustrated in FIG. 1;

FIGS. 4A-4C illustrate embodiments of portable devices incorporating a printing system according to the invention.

### DETAILED DESCRIPTION OF CERTAIN EMBODIMENTS

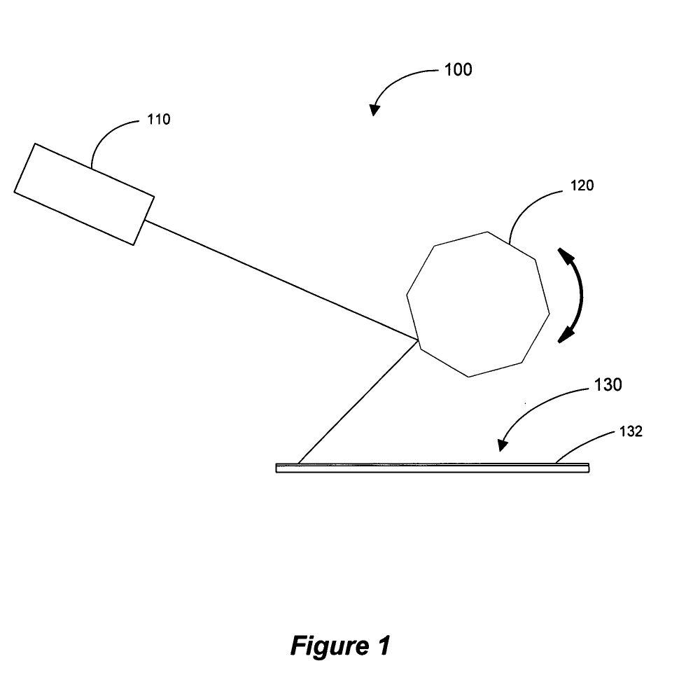

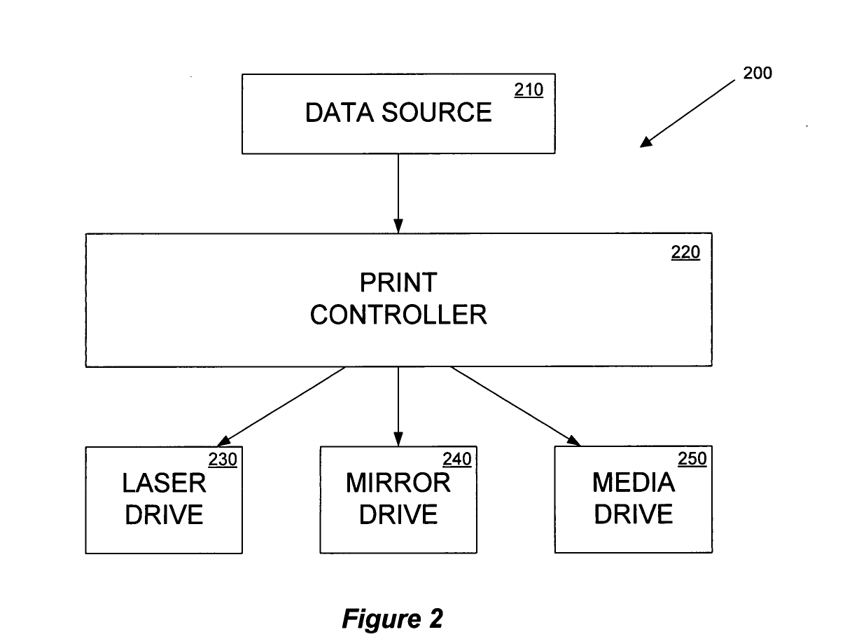

Referring to FIG. 1, an exemplary printing system is illustrated for printing on a print medium 130. The printing system 100 includes a light source, such as a laser 110, adapted to generate a light beam. In this regard, the term “light” is used to include various forms of energy. Thus, the light source may be any of a variety of energy sources. The light source 110 is in a fixed position and directs the light beam, or laser beam, in a fixed direction. In one embodiment, the laser is a laser having a wavelength between 380 and 1550 nm or a diode laser. In a particular embodiment, the light source 110 is small enough to fit within the housing of a portable device, such as a digital camera or a personal digital assistant. The laser may be controlled by a laser drive which may receive instructions from a print controller, as described below with reference to FIG. 2.

The system 100 also includes a reflective surface 120 positioned along the path of the light beam from the light source 110. In this regard, the reflective surface 120 is adapted to deflect the light beam from the light source 110 to the print medium 130. The reflective surface is also adapted to rotate to cause a change in the angle of incidence, and a corresponding change in the angle of reflectance, of the light beam. Thus, as the light beam strikes the rotating reflective surface, the rotation causes the deflected light beam to scan a scan region of the print medium 130. The scan region may include a line across a width of the print medium. The rotation of the reflective surface 120 may be controlled by a mirror drive adapted to receive instructions from a print controller, as described below with reference to FIG. 2. In some embodiments, the reflective surface 120 may be provided with degrees of freedom in addition to the rotation about a spin axis, as indicated by the curved arrow in FIG. 1. For example, the orientation and/or position of the spin axis may be shifted. In this regard, the relative position of the light source 110 and the reflective surface 120 may be dithered, manipulated or jittered. Such an effect may be achieved through piezo-elements, for example.

The reflective surface 120 may be formed in a variety of configurations. For example, the reflective surface may be a flat mirror or a multi-sided polygon. In a particular embodiment, the reflective surface includes a multifaceted mirror formed as, for example, a regular polygon. In the embodiment illustrated in FIG. 1, the reflective surface 120 is formed as a regular octagon. Thus, as the reflective surface rotates, the light beam striking one side of the octagon scans the scan region. After sufficient rotation, the light beam begins striking a second side of the octagon, and the light beam begins the scan again.

The print medium 130 is provided with a light-sensitive labeling layer 132. In a particular embodiment, the print medium 130 is a paper, and the light-sensitive labeling layer 132 includes a layer of a light-sensitive coating. The coating may be formed of a color former such as a leuco dye, an activator such as phenol, and an antenna such as indocyanine green. One such coating is described in U.S. Patent Application Publication No. 2003/0108708 A1. Additional embodiments of a light-sensitive labeling layer 132 are described in U.S. patent application Ser. No. 10/351,188, entitled “Compositions, Systems, and Methods for Imaging,” filed Jan. 24, 2003.

The light-sensitive labeling layer 132 of the print medium 130 is adapted to be activated by the light beam. In this regard, one embodiment of the light-sensitive labeling layer 132 may transition from transparent to grayscale upon activation. The activation of the labeling layer 132 includes a chemical change in the labeling layer to form an image, such as a visual image or an image in the non-visual spectrum. Thus, unlike conventional printers, deposition of additional materials, such as toner, onto the print medium is unnecessary, eliminating the need to store such materials within the printing device.

In other embodiments, the light-sensitive labeling layer 132 may be formed as pixels. Each pixel may be adapted to transition from transparent to a predetermined color upon activation. Thus, a pixilated image may be formed when the light-sensitive labeling layer 132 is activated. The pixels may be adapted to form any of three or more colors. For example, in one embodiment, each pixel may be adapted to form cyan, magenta or yellow when activated. In another embodiment, the pixels may be adapted to form red, blue and green. Embodiments of pixilated light-sensitive labeling layers, for example, for color labeling are described in U.S. patent application Ser. No. 10/834,744, entitled “System and Method for Synchronization of Pixilated Labeling Media,” filed Apr. 28, 2004.

The activation of the light-sensitive labeling layer may be achieved by providing a laser light source that is tuned to produce a beam having a wavelength and a power adapted to activate the light-sensitive labeling layer. For example, the wavelength and the power may be selected to activate an antenna in the labeling layer 132. In one embodiment, the light wavelength is approximately 780 nm, and the laser power ranges between 5 mW and 100 mW.

The print medium 130 with the light-sensitive labeling layer 132 is adapted to be driven through the scan region. Thus, once a line of the print medium 130 has been scanned, the print medium may be indexed to allow scanning of additional regions of the print medium. In this regard, the indexing causes the print medium to be moved in one or more directions, such as a direction perpendicular to the plane illustrated in FIG. 1. The indexing of the print medium 130 may be controlled by a print medium drive adapted to receive instructions from a print controller, as described below with reference to FIG. 2.

Referring now to FIG. 2, a control system for the printing system illustrated in FIG. 1 is schematically illustrated. The control system 200 includes a print controller 220 adapted to control operation of the various components of the printing system 100 of FIG. 1.

The print controller 220 is adapted to receive instructions or data from a data source 210, such as a CPU or a memory device, of a device containing the printing system 100. In this regard, print instructions or data relating to an image to be printed may be delivered from the data source 210 to the print controller 220.

The print controller 220 is adapted to communicate with drivers for the various components of the printing system 100. In the illustrated embodiment, the print controller 220 is adapted to communicate with a laser drive 230, a mirror drive 240 and a media drive 250. Thus, the print controller 220 can transmit commands to the laser drive 230 to, for example, turn on or off the light source 110 to selectively activate areas of the light-sensitive labeling layer. In this regard, the print controller 220 may transmit control signals to the laser drive 230 to cause the laser to generate a pulse or pulses of electromagnetic radiation. The control signals may be generated responsive to image data or instructions received from the data source 210, for example, as well as the position of the print medium and the rotational position of the reflective surface 120.

The radiation is directed to the light-sensitive labeling layer of a print medium. The radiation causes a chemical change in the light-sensitive labeling layer to form an image. In this regard, a pulse may form a spot on the labeling layer, for example. In an exemplary embodiment, the pulse length required to form an image on a print medium may depend on the size of the spots, as determined, at least in part, by the control of the focus, the power, relative velocity of the electromagnetic radiation emitter across the surface of the print medium, the size of the image, the vertical print density and the sensitivity of the medium. In an exemplary embodiment, the sensitivity of the medium may be determined by various parameters, such as thickness of the light-sensitive labeling layer, concentration of a radiation absorber within the labeling layer, and transition temperatures and energy of color reaction.

In an exemplary embodiment, the electromagnetic radiation source has a laser with a pulse width of 70 nanoseconds. In one exemplary embodiment, the controller controls the electromagnetic radiation source with an on/off cycle of about 1 μsec to 1000 μsec to create optically detectible areas in the medium. In another exemplary embodiment, the on/off cycle is, for example, from about 10 μsec to about 80 μsec.

In one exemplary embodiment, the focus spot dimensions containing 90% of the energy envelope are between 1 μm to 1000 μm. In another exemplary embodiment, the spot dimension is, for example between 10 μm to 50 μm and may be between 19 and 20 μm, representing a line width of about 20 μm, roughly corresponding to a resolution of 2400 dots per inch.

In an exemplary embodiment, the writing speed may be determined primarily by the energy delivered or emitted by the electromagnetic radiation emitter. In an exemplary embodiment, the energy delivered is between 1 mJ/cm² to 2000 mJ/cm², for example between 100 and 200 mJ/cm². In one exemplary embodiment, a laser of 35 mw power output has a linear speed between 1 cm/sec to 500 cm/sec. In another exemplary embodiment, the linear speed may be from 10 to 500 cm/sec, or from 100 to 400 cm/sec.

In exemplary embodiments, the print controller 220 can transmit instructions to the mirror drive 240 to, for example, control the rate of rotation of the reflective surface 120. The rate of rotation of the reflective surface 120 corresponds to the linear speed of the laser across the print medium. The mirror drive 240, in turn, may actuate a motor to control the rotation of the reflective surface 120. Also, the print controller 220 can communicate with the media drive 250 to control the indexing of the print medium. In this regard, the media drive 250 may be adapted to control rollers or other mechanism to control movement of the print medium through the scan region.

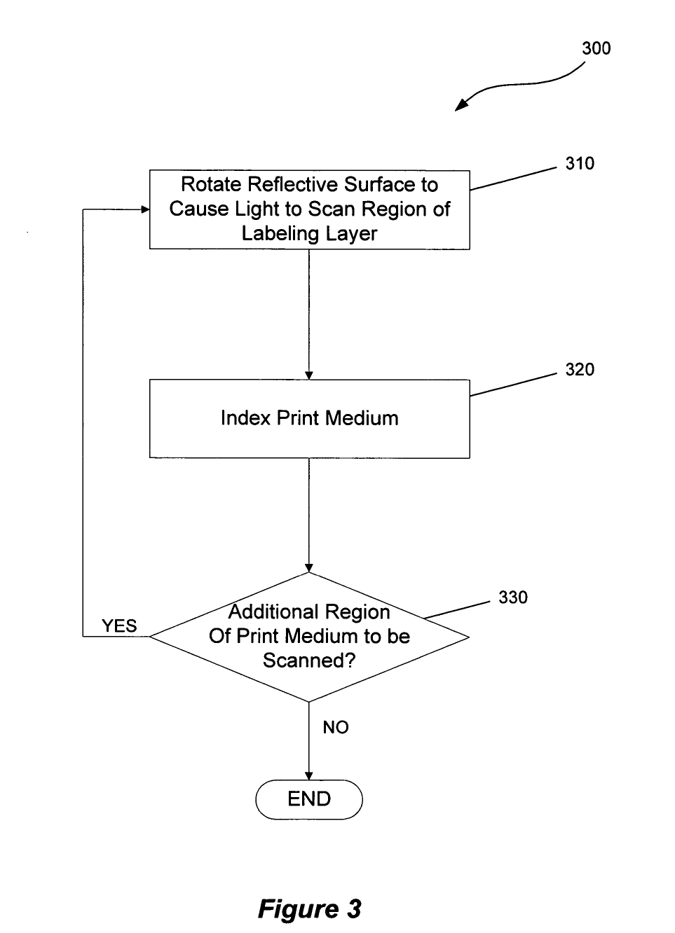

Referring now to FIG. 3, an embodiment of an operational process of the printing system illustrated in FIG. 1 is illustrated. With the light source 110 generating a light beam, the process 300 includes rotating the reflective surface 120 to cause the light beam to scan a region of the labeling layer of the print medium (block 310). As the light scans the region, it activates the light-sensitive labeling layer in that region. At block 320, the print medium is indexed to move the print medium to allow other regions of the print medium to be scanned. At block 330, a determination is made as to whether additional regions of the print medium remain to be scanned. If the determination is made that additional regions remain, the process 300 returns to block 310 to scan another region of the print medium. On the other hand, if the determination is made that no other regions remain to be scanned, the process 300 concludes that either the desired image has been completely printed or the print medium has been completely printed upon. Accordingly, the process terminates.

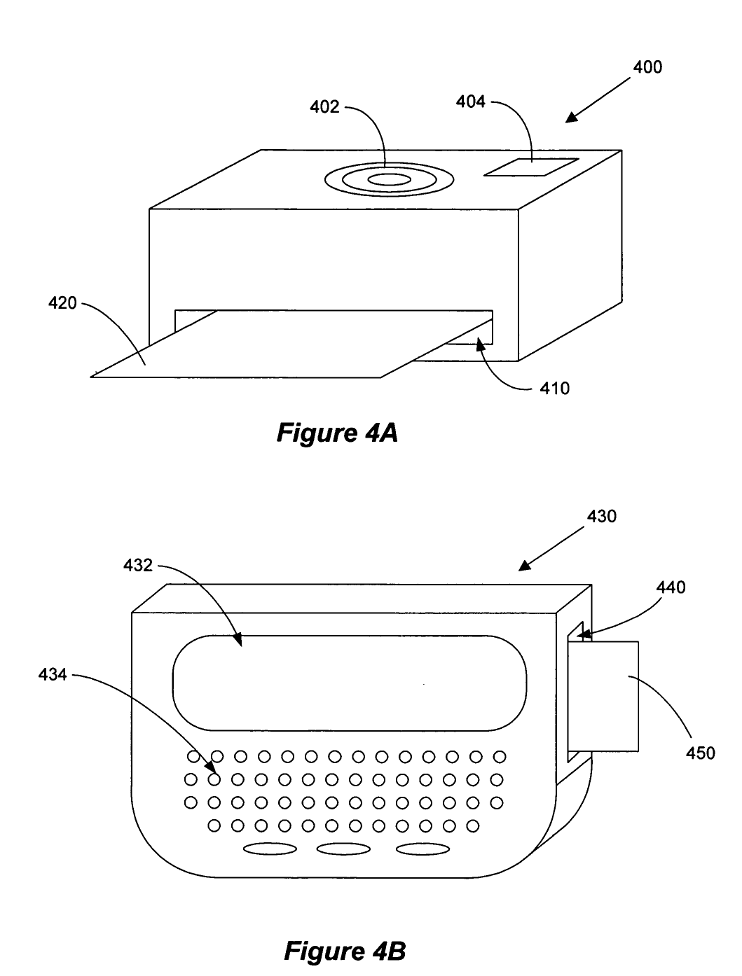

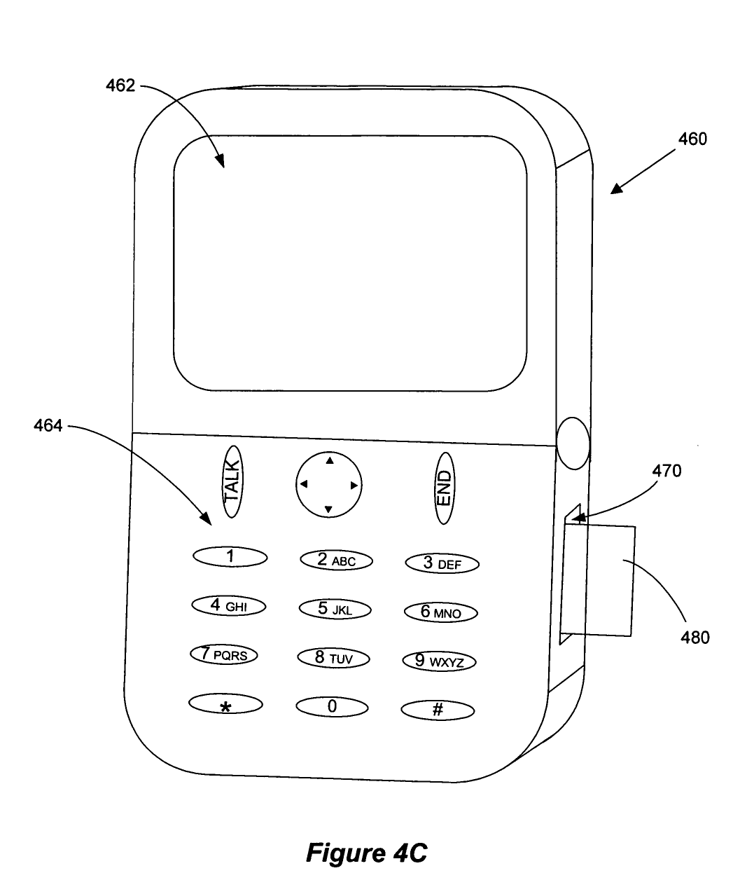

Thus, with a scanning light beam activating a layer on a print medium, the need to accommodate ink cartridges is eliminated. Accordingly, the printing system described above may be made sufficiently small to be housed within certain portable devices. FIGS. 4A and 4B illustrate exemplary embodiments of portable devices in which the printing system described above may be implemented. FIG. 4A illustrates a digital camera 400 having a lens 402 and a flash 404 to facilitate capture of an image. The digital camera 400 also includes an output slot 410 adapted to dispense a print medium 420. When a user desires to print a captured image, the printing system housed within the digital camera is capable of printing the image on the print medium having the light-sensitive labeling layer and outputting the print medium through the output slot 410.

Similarly, FIG. 4B illustrates a personal digital assistant (PDA) 430 adapted to house a printing system similar to that described above. The PDA 430 is provided with a display portion 432 and a keyboard portion 434. The PDA 430 may receive data or images as attachments to e-mails, for example, or may be provided with digital camera capability. To print the data or images, the PDA 430 may be provided with a printing system (not shown) within the housing of the PDA 430. The PDA 430 includes an output slot 440 adapted to dispense a print medium 450.

Further, FIG. 4C illustrates a portable phone 460, such as a cellular phone, adapted to house a printing system similar to that described above. The portable phone 460 is provided with a display portion 462 and a keypad 464. The portable phone 460 may also be provided with a built-in digital camera to capture images for printing. To print the images, the portable phone 460 may be provided with a printing system (not shown) within the housing of the portable phone 460. The portable phone 460 includes an output slot 470 adapted to dispense a print medium 480.

The examples described above relate to printing of images. It will be understood by those skilled in the art that the systems, devices and methods described above may also be used to print simple text or graphics.

The foregoing description of embodiments of the invention have been presented for purposes of illustration and description. It is not intended to be exhaustive or to limit the invention to the precise form disclosed, and modifications and variation are possible in light of the above teachings or may be acquired from practice of the invention. The embodiment was chosen and described in order to explain the principles of the invention and its practical application to enable one skilled in the art to utilize the invention in various embodiments and with various modification as are suited to the particular use contemplated. It is intended that the scope of the invention be defined by the claims appended hereto and their equivalents.

What is claimed is:

1. A system for printing on a print medium having a light-sensitive labeling layer, comprising:
a light source adapted to generate a light beam; and
a reflective surface adapted to deflect the light beam from the light source to a light-sensitive labeling layer of a print medium, the reflective surface being further adapted to rotate to cause the light beam to scan a scan region of the labeling layer;
wherein the light beam is adapted to activate the light-sensitive labeling layer of the print medium by causing a chemical change in the light-sensitive labeling layer to form an image.

2. The system according to claim 1, wherein the reflective surface includes a multifaceted mirror.

3. The system according to claim 2, wherein the multifaceted mirror is configured as a regular polygon.

4. The system according to claim 1, wherein the light source is a laser and the light beam is a laser beam.

5. The system according to claim 14, wherein the laser produces a laser beam having a wavelength adapted to activate the light-sensitive labeling layer.

6. The system according to claim 1, wherein the print medium is paper.

7. The system according to claim 1, wherein the light-sensitive labeling layer is adapted to transition from transparent to grayscale upon activation.

8. The system according to claim 1, wherein the light-sensitive labeling layer includes pixels, each pixel being adapted to transition from transparent to a predetermined color upon activation.

9. The system according to claim 8, wherein each predetermined color is one of cyan, magenta and yellow.

10. The system according to claim 8, wherein each predetermined color is one of red, blue and green.

11. The system according to claim 1, wherein the scan region includes a line across a width of the print medium.

12. The system according to claim 1, further comprising:
a print medium driver adapted to drive the print medium through the scan region, the print medium driver being further adapted to index the print medium to allow the light to scan additional regions of the labeling layer.

13. The system according to claim 12, further comprising:
a controller adapted to control the light source, the reflective surface and the print medium drive, the controller adapted to receive instructions associated with an image to be printed on the print medium.

14. A method of printing on a print medium having a light-sensitive labeling layer, comprising:
rotating a reflective surface adapted to deflect a light from a light source to a light-sensitive labeling layer of a print medium, the rotating causing the light to scan a scan region of the labeling layer, the light being adapted to activate the light-sensitive labeling layer by causing a chemical change in the light-sensitive labeling layer to form an image.

15. The method according to claim 14, wherein the reflective surface includes a multifaceted mirror.

16. The method according to claim 15, wherein the multifaceted mirror is configured as a regular polygon.

17. The method according to claim 14, wherein the light source is a laser and the light is a laser beam.

18. The method according to claim 17, wherein the laser produces a laser beam having a wavelength adapted to activate the light-sensitive labeling layer.

19. The method according to claim 14, wherein the print medium is paper.

20. The method according to claim 14, wherein the light-sensitive labeling layer is adapted to transition from transparent to grayscale upon activation.

21. The method according to claim 14, wherein the light-sensitive labeling layer includes pixels, each pixel being adapted to transition from transparent to a predetermined color upon activation.

22. The method according to claim 21, wherein each predetermined color is one of cyan, magenta and yellow.

23. The method according to claim 21, wherein each predetermined color is one of red, blue and green.

24. The method according to claim 14, wherein the scan region includes a line across a width of the print medium.

25. The method according to claim 14, further comprising:
indexing the print medium to allow the light to scan additional regions of the labeling layer.

26. The method according to claim 25, further comprising:
repeating the rotating and the indexing until at least one of all regions of the print medium are scanned and printing of a desired image on the print medium is completed.

27. A portable device, comprising:
a printing system, the printing system comprising:
a light source adapted to generate a light beam; and
a reflective surface adapted to deflect the light beam from the light source to a light-sensitive labeling layer of a print medium, the reflective surface being further adapted to rotate to cause the light beam to scan a scan region of the labeling layer;
wherein the light beam is adapted to activate the light-sensitive labeling layer of the print medium by causing a chemical change in the light-sensitive labeling layer to form an image.

28. The portable device according to claim 27, wherein the portable device includes a digital camera.

29. The portable device according to claim 27, wherein the portable device includes a handheld device.

30. The portable device according to claim 27, wherein the handheld device is selected from a group consisting of a personal digital assistant and a portable telephone.

31. A program product, comprising machine readable program code for causing a machine to perform the following method steps:
rotating a reflective surface adapted to deflect a light from a light source to a light-sensitive labeling layer of a print medium, the rotating causing the light to scan a scan region of the labeling layer, the light being adapted to activate the light-sensitive labeling layer by causing a chemical change in the light-sensitive labeling layer to form an image.

32. A system for printing on a print medium having a light-sensitive labeling layer, comprising:
means for generating a light beam; and
means for deflecting the light beam to a light-sensitive labeling layer of a print medium, the means for deflecting being further adapted to rotate to cause the light beam to scan a scan region of the labeling layer;
wherein the light beam is adapted to activate the light-sensitive labeling layer of the print medium by causing a chemical change in the light-sensitive labeling layer to form an image.
